(19) United States
(12) Patent Application Publication
(10) Pub. No.: US 2014/0201623 A1
(43) Pub. Date: Jul. 17, 2014

(54) METHOD AND SYSTEM FOR DETERMINING AND USING STYLE ATTRIBUTES OF WEB CONTENT

(71) Applicant: BAZAARVOICE, INC., Austin, TX (US)

(72) Inventors: J. Stephen Kattner, Austin, TX (US); Michael D. Norman, Austin, TX (US)

(73) Assignee: Bazaarvoice, Inc, Austin, TX (US)

(21) Appl. No.: 13/744,206

(22) Filed: Jan. 17, 2013

(51) Int. Cl. G06F 17/21

(52) U.S. Cl. CPC G06F 17/218
USPC 715/235

(57) ABSTRACT

Embodiments of systems and methods for determining style attributes of a web page are disclosed. More specifically, in one embodiment, an indication of a document corresponding to a web page may be received and one or more style attributes associated with the web page determined. To determine these style attributes, a document object model (DOM) may be produced based on the document corresponding to the web page and the analyzed DOM. Information indicative of the one or more style attributes can then be generated.

### TECHNICAL FIELD

This disclosure relates generally to the styling of web content. In particular, this disclosure relates to the determination and use of styling attributes of web content. Even more specifically, this disclosure relates to the determination of styling attributes of web content and conforming web content to those styling attributes.

### BACKGROUND

For a wide variety of reasons it may be desired to determine the styling associated with a web site or web content of a web site, such as web pages or portions thereof. For example, many web site providers may incorporate web content (referred to as “incorporated web content”) into particular web pages (referred to as “parent web pages”) of their web site. This incorporated web content may in some cases be provided by a different entity than the provider of the parent web site. Some providers of incorporated, web content have ignored the styling of the parent web pages into which the content is being incorporated, and instead use their own default styling. Providers of the parent web pages may not be copasetic with this approach, as they may wish to retain a consistent appearance of the parent web page. Thus, providers of the parent web pages may desire to conform this incorporated web content to the style of the parent web pages.

In conventional techniques, providers of the incorporated web content may manually analyze the parent web page and create custom style sheets to conform the incorporated web content to the styling of the parent web page. As may be imagined, this process may be both resource and time intensive.

### BRIEF DESCRIPTION OF THE DRAWINGS

The drawings accompanying and forming part of this specification are included to depict certain aspects of embodiments. A clearer impression of embodiments, and of the components and operation of systems provided with embodiments, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a block diagram of a topology including one embodiment of a system for determining and using style attributes of web content.

FIG. 2A is a block diagram of one embodiment of a style analysis system that may be employed in the system depicted in FIG. 1.

FIG. 2B is a block diagram of one embodiment of a data store.

FIG. 2C is a block diagram of one embodiment of a server.

FIG. 3 is a flow diagram of one embodiment of a method for generating information indicative of style attributes.

FIG. 4 is a flow diagram of one embodiment of a method for associating values for style attributes with web content.

FIG. 5 depicts one example of a rendered web page that may be provided by various embodiments of the present disclosure.

FIG. 6 depicts one example of an interface that may be used in connection with various embodiments of the present disclosure.

FIGS. 7A and 7B depict one example of an interface that may be used in connection with various embodiments of the present disclosure.

FIGS. 8A and 8B depict one example of an interface that may be used in connection with various embodiments of the present disclosure.

FIG. 9 depicts one example of an interface that may be used in connection with various embodiments of the present disclosure.

FIG. 10 depicts one example of an interface that may be used in connection with various embodiments of the present disclosure.

FIG. 11 depicts one example of an interface that may be used in connection with various embodiments of the present disclosure.

### DETAILED DESCRIPTION

The present methods and systems for determining and using style attributes of web content, and various features and advantageous details thereof, are explained more fully with reference to the nonlimiting embodiments that are illustrated in the accompanying drawings and detailed in the following description. Descriptions of well-known starting materials, processing techniques, components and equipment are omitted so as not to unnecessarily obscure the description of the embodiments. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented as suitable computer-executable instructions that may reside on a computer readable medium (e.g., a hard disk (HD)), hardware circuitry or the like, or any combination.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited only those elements but may include other elements not expressly listed or inherent to such processes, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Embodiments can be implemented in one or more computers communicatively coupled to a network (for example, the Internet) and/or in one or more standalone computers. As is known to those skilled in the art, an exemplary computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylus, etc.), or the like. In some embodiments, the computer has access to at least one database over the network.

ROM, RAM, and HD are computer memories for storing computer-executable instructions executable by the computer system (e.g., using the CPU) or capable of being complied or interpreted to be executable by the computer system. Within this disclosure, the term “computer readable medium” is not limited to ROM, RAM, and HD and can include any type of data storage medium that can be read by a computer system. For example, a computer-readable medium may refer to a data cartridge, a data backup magnetic tape, a floppy diskette, a flash memory drive, an optical data storage drive (e.g., CD, DVD), memory (e.g., ROM, RAM), HD, or other suitable storage devices (or collections of storage devices). The processes described herein may be implemented by a computer system performing operations in response to execution of computer-executable instructions that may reside (e.g., stored as software code) on a computer readable medium.

In one exemplary embodiment, the computer-executable instructions may include instructions in one or more programming or scripting languages, such as C++, Java, JavaScript, HTML, or any other programming or scripting language. Various software/hardware/network architectures may be used. For example, the various features of the embodiments may be implemented on one computer or shared among two or more computers. In one embodiment, various aspects may be distributed in the network. Communications between computers implementing particular embodiments can be accomplished using any electronic, optical, or radio frequency signal, or other suitable methods and tools of communication in compliance with known network protocols.

It will be noted that the term “computer system” has its ordinary and accepted meaning in the art, and includes one or more computing devices operating together and any instructions stored thereon. A computing device may include one or more processor units and a memory subsystem including a computer readable medium. A memory subsystem may store program instructions executable using the one or more processor units. The term “server” also has its ordinary and accepted meaning in the art, which includes one or more computer systems that are configured to handle requests from client computer systems—e.g., for services, data (including files, web pages, etc.), and so on.

As used herein, the term “configured to” means that a particular piece of hardware, or computer instructions, or some combination, are arranged to perform a particular task or tasks when operated. Thus, a computer system that is “configured to” perform task “A” means that the computer system includes a circuit, program instructions stored in memory, or other structure that, during operation of a computer system, performs or can be used to perform task A. As such, a computer system can be “configured to” perform task A even if the computer system is not currently on. Similarly, computer executable instructions or a computer readable medium that is “configured to” perform task B includes instructions that, if executed by a computer system, perform task B. A “module” may be hardware, instructions, or other structure, or some combination that is configured to perform a particular task.

Before discussing specific embodiments, a brief overview of the context of the disclosure may be helpful. As discussed above, it may be desired to determine the styling (e.g., font types, font colors, font sizes, non-font colors, line weights, spacings) associated with a web site (or specific portions of a web site, such as web pages or portions thereof). For example, providers of a web site may desire to determine the current styling associated with the included web pages to ensure that the web pages conform to a particular design standard, to identify non-conforming elements, to help construct design standards or guidelines, or for a wide variety of other reasons.

Determining the styles that are used within particular web pages may be particularly useful in cases where web content supplied by a particular entity is incorporated into a portion of one or more parent web pages that may be designed and/or provided by a different entity. In these cases, providers of the parent web pages may desire that the incorporated web content, conform to the existing style of the parent web pages. In many cases, however, it may not be possible to automatically conform the styling of the incorporated web content to the styling of the parent web page solely by relying on the style definitions of the parent web page, as the incorporated web content may include styling elements or classes of elements that are, for example, not defined for the parent web page (e.g., elements that are not defined in a style sheet associated with the parent web page).

Conventional techniques may address the styling of incorporated content by manually analyzing the parent web page and manually creating custom definitions (e.g., custom style sheets) that attempt to conform the incorporated web content to the styling of the parent web page. Such processes may be both resource and time intensive.

Some conventional techniques provide a fixed set of choices of possible styles for incorporated content. These choices, however, often differ from the actual styles used within the parent web page, and may thus result in a non-uniform appearance for the parent web page due to the non-conforming incorporated content.

As one example of incorporating content into a parent web page, consider the context of user-generated content. In some cases, user-generated content may be incorporated into a parent web page operated by, for example, a merchant (“merchant” as used herein refers to any entity involved in the production, marketing, or selling of a product or service via, for example online and/or “brick and mortar” channels). This user-generated content may include data such as user reviews, user stories, ratings, comments, descriptions of problems and issues, questions/answers, or other types of content which, for example, a user may be allowed to compose or submit through online or other methods.

In some cases, the user-generated content that is incorporated into a merchant's parent web page may be supplied by a third party that is different from the entity that provides the merchant's parent web page. For example, the merchant or a parent web site provider may provide the merchant's parent web page to an end user. In some cases, the parent web page may allow content that is provided by the third party (a different entity than the merchant or the parent web site provider) to be incorporated into the parent web page that is rendered for the end user.

Such arrangements that use third parties to provide user-generated content may facilitate greater efficiencies and/or greater capabilities with respect to content processing. For example, a third party may be a processor of user-generated content and may have particular collection and processing capabilities. In some cases, such a third party processor may have access to a larger volume of user-generated content (e.g., content collected from various sources other than the merchant's web pages).

In some cases, the merchant may desire that such third party-supplied user-generated content be seamlessly incorporated into the parent web page, such that all content (including the incorporated third party-supplied content) that is rendered on the parent web page is presented to the user with consistent styles. Thus, the merchant may desire that the incorporated third party-supplied content conform to the styles that are used in other portions of the merchant's parent web page. As can be seen then, it may be useful for the third party providers of the user-generated content to be able to both determine the style attributes of a web page into which the user-generated content may be incorporated, and additionally to be able to conform the user-generated content to these styling attributes.

To that end, among others, attention is now directed to exemplary embodiments of systems and methods for determining and using style attributes of web content. In various embodiments, an indication of a document corresponding to a web page may be received, and one or more style attributes associated with the web page may be determined. In particular, in one embodiment, determining these style attributes may include producing a document object model (DOM) based on the document corresponding to the web page, and analyzing the produced DOM to determine style attributes associated with the web page. Information indicative of the one or more style attributes can be generated.

These style attributes may include, in one embodiment, font-related style attributes and color-related non-font style attributes. Font-related style attributes may include style attributes associated with textual elements of web content, including for example body text associated with a body portion of the web content, heading text associated with headings of the web content, link text associated with a hyperlink in the web content, or other textual elements. In some cases, style attributes associated with link text may include several variations, such as link text associated with a hovered link (e.g. a link with a cursor or pointer placed over or sufficiently near the link), link text associated with a visited link (e.g. a link that has been previously selected), link text associated with an unvisited link (e.g. a link that has not been previously selected), or other variations. Font-related style attributes may include, for example, font style, font size, font color, font weight, etc.

Color-related (non-font) style attributes may include style attributes associated with the color of non-font elements of the web content, including the background color of elements (e.g., the background color of graphic elements or textual elements), the colors used within images, or the color of other elements of the web content.

Other types of style attributes may also be included. For example, layout-related style attributes may include style attributes related to borders, margins, line spacings, character padding, etc., that are associated with the web page.

To continue with the above example in more detail, examples of a font-related style attribute “font style” may include values such as “Courier New”, “Arial”, “Times New Roman”, etc. Examples of a font-related style attribute “font size” may include values such as “10 Point”, “12 Point”, “13 Point”, etc. Examples of a font-related style attribute “font weight” may include values such as “Normal”, “Bold”, etc. Examples of a font-related style attribute “font color” may include a set of color values (e.g. specified in hexadecimal format or otherwise). Similarly, color-related attributes relating to background colors or image colors may also include color value representations.

Continuing with the example, information indicative of the one or more determined style attributes may be generated. The generated information may be configured to present a user with an identification of a particular element of the web content and a representation of one or more style attributes values associated with that particular element. In some cases, the representation may be textual. In some cases, the representation may additionally or alternately include a graphic representation of the style attribute value.

In one embodiment, a graphic representation of a style attribute value may include text describing the particular style attribute value, where the text is rendered in accordance with that particular style attribute value. For example, a graphic representation of a style attribute value corresponding to “13 point font size” may be displayed using text having a font size of 13 point. Similarly, a graphic representation of a style attribute value corresponding to “Arial font style” may be displayed using Arial font style text. As another example, a graphic representation of an image color style attribute value corresponding to the shade of blue defined as hex color #1a75cf may be displayed using text rendered in the color corresponding to $1a75cf. In some embodiments, these various representations, as well as other additional representations, may be combined (e.g., a description may be presented using a combination of attribute values (13 point font size, Arial font style, color #1a75cf, italics, bold) that also textually describes these attribute values).

The various determined style attribute values for a web page may in some cases be presented to a user as a list that is ordered based on the frequency of occurrence for each value. In various cases, the determined style attribute values may be presented as a list that is ordered based on metrics such as the number of characters corresponding to each style attribute value or the number of pixels corresponding to each style attribute value. For example, style attribute values relating to font size may be ordered based on the quantity of characters having each font size, style attribute values relating to font style may be ordered based on the quantity of characters having each font style, and style attribute values relating to image color may be ordered based on the quantity of pixels corresponding to each color. In some cases, combinations or style attribute values (e.g., number of characters corresponding to each of various combinations of font size, font style, font color, etc.) may be used for ordering listed combinations of style attribute values.

In some cases, the above-described ordered list of determined style attribute values may be used to determine default style attribute values (e.g., default values for font-related and color-related style attributes) for features that are to be incorporated into a web page. For example, the ordered list may be traversed to determine appropriate values for mapping style attributes of incorporated features.

The determined style attribute values may be utilized for a variety of purposes. For example, determined style attribute values corresponding to all text on a particular web page may be analyzed in view of a style guide relating to that particular web page. Such analysis may be used to identify existing text elements that are non-compliant with allowed styles that are defined by the style guide.

In one embodiment, the determined style attribute values may be utilized to ensure that content that is to be incorporated into a parent web page conforms to the style attribute values that are otherwise present in that parent web page. For example, candidate content that is to be incorporated may be mapped to one or more of the parent web page's already-present style attribute values to ensure consistency in presentation. In certain embodiments, such a mapping may include presenting a user with the candidate content elements and a set of possible style attribute values, where the set of possible style attribute values are determined based on the analysis of the parent web page. In some embodiments, the user may then manually select a style attribute value for each of the candidate content elements. In some embodiments, the style attribute values that are mapped to the candidate content may be automatically mapped (e.g., based on the ordering of the determined style attribute values, based on tags, and/or based on other predefined rules).

Alternatively, in some embodiments, the elements of the candidate content may be mapped to corresponding existing elements in the parent web page in order to determine appropriate style attribute values. For example, a candidate heading may be mapped to an already existing heading and accordingly the candidate heading text may be mapped to style attribute values used in the text of the already-existing heading. In some cases, the user may also be given the opportunity to override these style attribute value assignments by selecting a different style attribute value from a set of presented possible style attributes values (e.g., a list of style attribute values that are present in the parent web page).

In some cases, a style sheet may be created based on the style attributes values that are applied (e.g., automatically assigned or user selected) to the elements of the candidate content. When this web content is subsequently incorporated into the parent web page, the created style sheet may be provided to the browser that will be used to render the web content, such that the incorporated web content is rendered according to the style sheet. By ensuring that the style sheet defines style attribute values that are in accordance with the style attribute values already used in the parent web page, the subsequently incorporated candidate content elements may be rendered exclusively with already-used style attribute values of the parent web page.

It should be noted initially before proceeding further that while certain embodiments presented herein are described in conjunction with both the determination of style attributes of a web page and conforming candidate web content to be incorporated in that web page with those style attributes, other embodiments may effectively be utilized to perform only one or the other of these. For example, one embodiment may be utilized solely to determine style attributes of a web page, while another embodiment may solely be utilized to conform web content to style attributes. Furthermore, it should be understood that while embodiments have been described herein using multiple systems that may be controlled by different entities, other embodiments may be utilized with a lesser (including one) or greater number of computer systems that may be controlled by a lesser (including one) or greater number of entities.

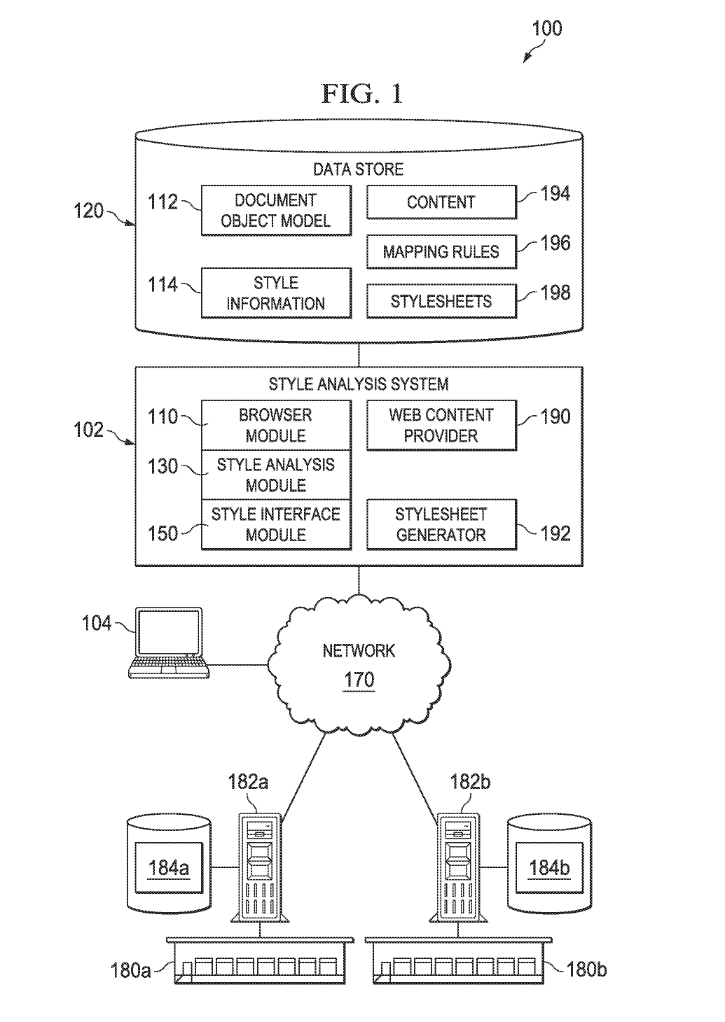

Turning now to FIG. 1, one embodiment of a topology that includes a style analysis system is depicted. Topology 100 includes a style analysis system 102 and data store 120, where style analysis system 102 may be coupled to computer device 104 and computing devices 182 over network 170. Computer devices 182 (e.g. 182a, 182b) may be associated with an entities 180 (e.g. 180a, 180b) and provide a web site including one or more web pages 184 (e.g. 184a, 184b). Network 170 may include a wired and/or wireless network, such as the Internet, an intranet, a local-area network (LAN), a wide-area network (WAN), a cellular network, a publicly switched telephone network (PSTN), and/or another type of network. It will be understood that network 170 may be a combination of multiple different kinds of wired or wireless networks.

Style analysis system 102 may include browser module 110, style analysis module 130 and style interface module 150. Style interface module 150 may be configured to provide an interface through which an indication of a document corresponding to a web page, such as a Universal Resource Identifier (URI) or a Universal Resource Locator (URL), may be received.

Browser module 110 may be configured to receive the indication of the document corresponding to the web page and retrieve the document. The retrieved document may, for example, include a hypertext markup language (HTML) document. Browser module 110 may also be configured to produce a DOM that is based on the retrieved document, and subsequently store this produced DOM (Document Object Model 112) in data store 120. This DOM 112 may be produced based on, for example, a cascading style sheet (CSS) provided in association with the retrieved document corresponding to the web page. Browser module 110 may be configured to provide access to functionality, including for example access to DOM 112, via an application programming interface (API). One example of such a browser module 110 is PhantomJS.

Style analysis module 130 may be configured to access and analyze the DOM 112. The style analysis module 130 may be configured to produce, based on its analysis of the DOM 112, style information 114 indicative of style attributes of the web page corresponding to the document from which the DOM 112 was produced. These style attributes may include font-related style attributes and/or color related style attributes as discussed above. Other types of style attributes may also be included. For example, layout-related style attributes may relate to a border, margin, line spacing, character padding, etc. associated with the web page.

The style information 114 may also comprise statistical information relating to the style attributes of the document. In one embodiment, DOM 112 may be traversed and analyzed to determine the statistical information. For example, style analysis module 130 may be configured to determine each leaf node in the DOM 112 in order to detect occurrences of various style attribute values. A leaf node as used herein indicates a node corresponding to elements that will be displayed when the web page corresponding to the document is rendered. Style elements associated with each of these leaf nodes may be obtained from the DOM 112. A number of characters having a particular style attribute value may then be determined for each leaf node, and this statistical information may be aggregated in style information 114. In some cases, white space or blank characters may be disregarded during this analysis.

To determine statistics relating to the color-related style attribute of background color, in one embodiment, the style analysis module 130 may, for example, analyze leaf nodes to determine the height and width of elements corresponding to background colors presented when the web page is rendered. The number of pixels of each particular background element can then be determined, and the style attribute value corresponding to the background color of that element may be obtained from the DOM 112. The number of pixels corresponding to each background color in each leaf node may be aggregated for the web page and stored.

Similarly, information relating to the color-related style attribute of other, non-background image colors may be determined. For example, in one embodiment style analysis module 130 may analyze the DOM 112 to determine a list of images indicated by the document corresponding to the web page, for example by locating an image tag in the DOM (e.g., “img src=”). Each one of these images can then be analyzed to determine the color associated with each of the pixels of the image. The number of pixels corresponding to each color may be aggregated for the web page and stored.

In some embodiments, when processing the image additional techniques may be utilized. For example, if an image comprises pixels that have a set of colors that are similar (e.g. within some Euclidian distance), a particular one of the set of colors (e.g., the member of the set of colors corresponding to the most pixels) may be stored as representing all pixels that were detected as corresponding to the set of similar colors. Furthermore, a dominant color may be selected for an image, based on the number of pixels of the image that is associated with each color. In some cases, a color may be discarded if the number of pixels corresponding to that color is under a certain threshold. In some cases, a limited number of colors (e.g. the 24 colors of the image with the most pixels) may be stored.

Style interface module 150 may be configured to present style information 114 through an interface. In one embodiment, this interface may be a text based interface that includes an identification of a type of element of the web page and a representation of the one or more style attribute values associated with that element. Specifically, in one embodiment, such an interface may include an identification of a type of element of the web page and a graphic representation of the style attribute value. For example, a graphic representation of a style attribute value may include text describing the particular style attribute value, where the text in rendered in accordance with that particular style attribute value, as has been discussed above and as will be discussed in more detail below.

Moreover, in certain embodiments, the style attribute values that are presented in the web page may be ordered based on a quantity of occurrence. For example, style attributes values may be displayed as ordered based on the quantity of occurrences of each value. The quantity of occurrences may include, for example, the quantity of character occurrences (e.g. the number of occurrences of a character with that style attribute value) or the quantity of color occurrence (e.g. the number of pixels having the style attribute value). Using these orderings, default style attributes, including for example default values for font-related or color-related style attributes, for elements within the web page may be created and stored in the information 114. These default values may be selected, for example, based on quantity of occurrence, or by some other method.

Accordingly, a web page 184a of a web site associated with an entity 180a (e.g., a retailer) may be analyzed using style analysis system 102. To illustrate in more detail, entity 180a may provide a web site using computing device 182a, where the web site includes a web page 184a accessible at a URI or URL over network 170. A user associated with entity 180a (or another type of user) may desire to analyze web page 184a. The user may provide an indication of the document associated with the web page (e.g., the URI or URL) to the style analysis system 102 using the style interface module 150.

Browser module 110 may retrieve the document corresponding to the web page 184a by sending a request for the URL or URI to computer device 182a. Browser module 110 may receive the document associated with the web page 184a and produce DOM 112 based on the document. This DOM 112 may be produced based on, for example, a cascading style sheet (CSS) provided in association with the document corresponding to the web page. Style analysis module 130 may access and analyze DOM 112 created by browser module 110. Based on the analysis of the DOM 112, style analysis module 130 may produce style information 114 that is indicative of the style attributes of the web page 184a. Style interface module 150 can then present style information 114 (or a subset thereof) to the user. The style interface module may present an identification of a type of element of the web page and a representation of one or more style attribute values associated with that element.

Using such an interface, then, a user may be able to easily and intuitively perceive the style attribute values utilized by the web page 184a. The user may thus be able to compare the style attribute values used in web page 184a with allowed styles for the web page 184a of the web site. Thus, various ones of the present embodiments may be used to identify one or more elements of web page 184a that are non-compliant with allowed styles for the web page.

In one embodiment, style analysis module 150 may be further configured to perform this non-compliance analysis automatically. In these types of embodiments, one or more allowed styles for web page 184a may be provided by entity 180a (e.g. using an interface provided by style interface module 150 or otherwise) and stored in data store 120. An allowed style may comprise a style attribute value associated with an element that entity 180a desires to be utilized for that element on web page 184a. Style analysis module 150 may compare the style information 114 corresponding to elements found on web page 184a to the allowed style attribute values for the web page 184a, and automatically identify any elements of web page 184a that are non-compliant with the allowed style attribute values. Identified non-compliant elements and associated information (e.g., the non-compliant style attribute value, a suggested compliant style attribute value) may be presented using an interface provided by style interface module 150.

As can be seen then, a user may not only easily and intuitively see the style attribute values utilized in web pages of a web site, but may also easily identify elements of web pages that are non-compliant with allowed styles for those web pages. Such functionality may allow a user to easily conform content of their web sites to desired styles.

In many cases, however, content that is included on a rendered web page may not be provided solely from one entity. In other words, when a web page that includes information provided by one entity is rendered, content supplied directly from another entity may be incorporated onto the rendered web page. For example, in some embodiments, style analysis system 102 may include web content provider 190.

Web content provider 190 may be configured to provide web content 194 in response to a request. A web page 184a (here the parent web page) of the web site of entity 180a may include code such as JavaScript, HTML, etc., such that when the web page 184a is rendered by a browser at a user's computer 104, a request may be sent to the web content provider 190. In response to this request, the web content provider 190 may provide content 194 (here the incorporated content) to the browser at the user's computer 104, which may subsequently render the incorporated content 194 along with the web page 184a such that the rendered web page 184a includes the rendered incorporated web content 194.

In many cases, entity 180a (e.g., the entity providing the web page 184a in which content 194 is to be incorporated) may desire that the incorporated content 194 conform to the styling of the other portions of web page 184a, such that the rendered web page 184a has a seamless appearance after incorporation of content 194. Thus, entity 180a may desire to conform incorporated web content 194 to the style attribute values used on the other portions of parent web page 184a. Accordingly, in one embodiment, style analysis module 130 may be further configured to determine style attribute values used in portions of parent web page 184a, thereby identifying style attribute value candidates for use with elements of incorporated web content 194. Stylesheet generator 192 may be configured to map the elements of incorporated web content 194 to the determined style attribute values, and in some cases to generate stylesheet 198 for incorporated web content 194.

In this manner, a browser at user device 104 that will render web page 184a may request web content 194 for incorporation into rendered web page 184a. For example, incorporated web content 194 may in some cases be requested by user device 104 directly from an incorporated content provider that is different than a parent page content provider that provides content corresponding to the other portions of web page 184a. The incorporated content provider-supplied elements specified by web content 194 that will be rendered as part of web page 184a may then be mapped to one or more allowable style attribute values (e.g., values that may be determined based on the parent page content provider-supplied information). One or more portions of web page 184a may then be rendered based on incorporated web content 194, along with the other portions of web page 194 that are rendered based on the parent page content provider-supplied information. In some cases, stylesheet 198 may be provided to the browser as one method to facilitate rendering the incorporated content in conformance with style attribute values of other portions of the parent web page 184a.

Mapping rules 196 may include rules corresponding to one or more elements of incorporated web content 194. For example, mapping rules 196 may describe the mapping of one or more elements of the incorporated web content 194 to style attribute values that are consistent with one or more corresponding elements that have been determined to be present in other portions of the parent web page 184a. Additionally or alternatively, mapping rules 196 may include rules associating each element of the incorporated web content 194 with one or more style attribute values that have been otherwise specified (e.g., via a guide defining allowable style attribute values) as being appropriate for parent web page 184a. The mapping rules may be provided to style analysis system 102, for example through style interface module 150, or may have been determined by style analysis system 102 (e.g., using style analysis module 130).

Style analysis module 130 may in some cases use mapping rules 196 to determine a corresponding element (e.g., in a different portion of the parent web page 184a) for each element in the incorporated web content 194 that will be rendered as part of web page 184a. The information 114 indicative of the style attribute values of the parent web page 184a may be used to determine one or more style attribute value found to be used for each corresponding element in the parent web page 184a. The style attribute value used for the elements in the parent web page 184a can then be applied to each corresponding element in the incorporated web content 194. The style attribute value determined to be used for an element of the parent web page 184a (and thus applied to the corresponding element of the incorporated web content 194) may, for example, be the set as a default style attribute value that may in some cases be subsequently adjusted.

The style attribute values applied to the elements in the incorporated web content 194 may be provided to stylesheet generator 192. Stylesheet generator 192 may be configured to generate a stylesheet 198 associated with incorporated web content 194, based on the style attribute values applied to the elements of the incorporated web content 194. The generated stylesheet 198 may be stored and associated with web page 184a and/or incorporated web content 194.

Alternatively or additionally, style interface module 150 may present an interface that allows a user to select a style attribute value to associate with an element of incorporated web content 194. In some cases, style analysis module 130 may use mapping rules 196 to determine one or more corresponding elements in other portions of the parent web page 184a for each element in the incorporated web content 194. The determined corresponding elements may be analyzed to identify information 114 that is indicative of candidate style attribute values that may be applied to the elements of incorporated web content 194. Style interface module 150 may present an interface that is configured to allow a user to apply one or more of the candidate style attribute values to various elements of incorporated web content 194.

In one embodiment, the one or more candidate style attribute values for a particular element may be presented according to an order, where the order was, for example, determined based on analysis of parent web page 184a and stored in information 114. Such an order may in some cases be based on a quantity of occurrence. For example, various style attribute values that are associated with a particular style attribute for an element may be ordered based on the quantity of occurrences of those values (e.g., various values for font size may be ordered based on the number of characters that are determined to corresponding to each of the font size values). Additionally, if a default style attribute value has been stored in information 114, the interface may associate a default value of the one or more style attribute values for the element, and visually indicate that such a default value has been associated with that style attribute of the element.

Furthermore, in one embodiment, such a user interface may present a graphic representation of each of the one or more values of the style attribute. For example, if the style attribute is a color-related style attribute, such as image color, the interface may present the one or more candidate values as a set of color blocks. Each color block can in some cases be presented with a value (e.g., a textual representation of a hex value for the color), and/or a depicted color corresponding with the value, and may be selectable through the user interface to apply the candidate value corresponding to the color block to the existing image color of that element (e.g., a non-conforming existing color may be updated by applying a conforming candidate color value).

When the user has selected style attribute values to associate with the elements in the incorporated web content 194, these values may be provided to stylesheet generator 192. Stylesheet generator 192 may be configured to generate a style sheet associated with incorporated web content 194 based on the style attribute values that were selected by the user.

The generated stylesheet 198 may be stored and associated with web page 184a. Subsequently, the stylesheet 198 may be provided along with incorporated web content 194 in response to a request by a browser at user's computer 104 for incorporated web content 194 (e.g., as part of the browser rendering web page 184a). Accordingly, incorporated content 194 may be rendered according to the stylesheet 198 and therefore conform to style attribute values determined from the parent web page 184a and/or selected by a user.

It should be noted initially before proceeding further that while certain embodiments presented herein are described in conjunction with a style analysis system that may provide incorporated web content and analyze web pages provided by a separate computer system, these descriptions and embodiments should not be taken as limiting the scope of other embodiments. For example, other embodiments may be usefully applied in cases where incorporated web content is provided by another system, or where no web content is provided or incorporated in the web page being analyzed; where the style analysis system and the system providing the web page being analyzed are controlled or owned by the same, or different, entities; or for the style analysis of web pages for almost any purpose desired.

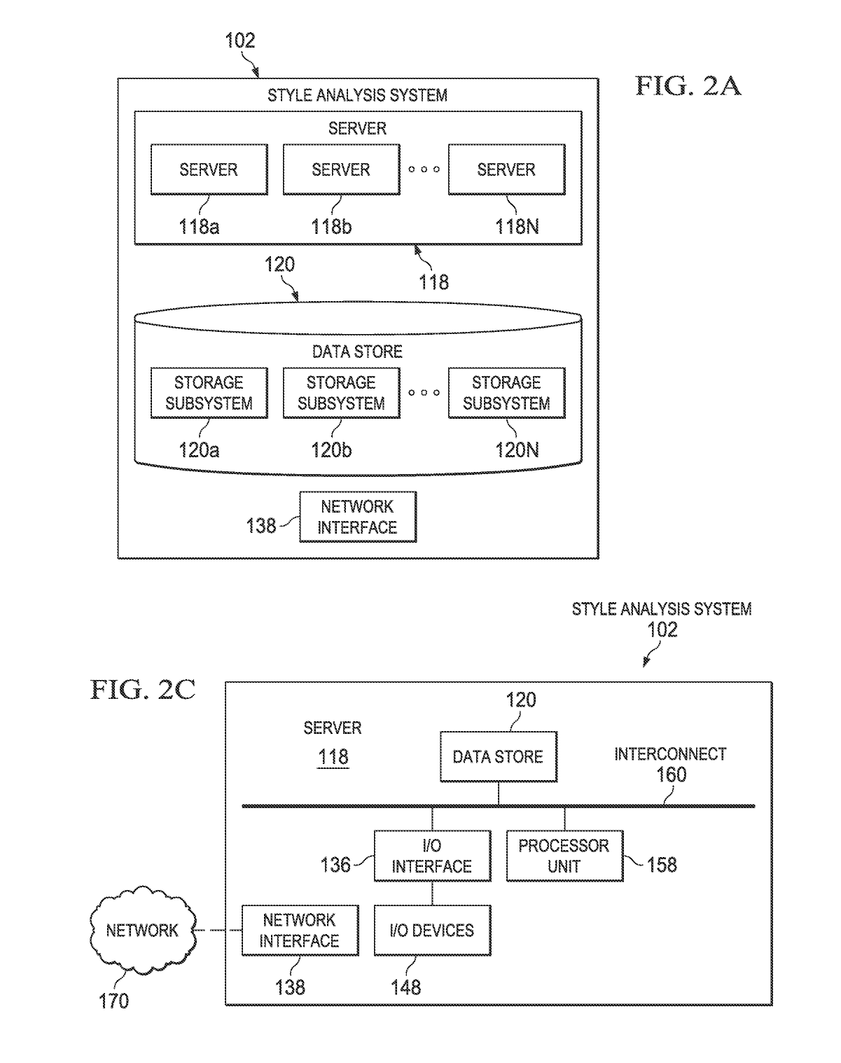

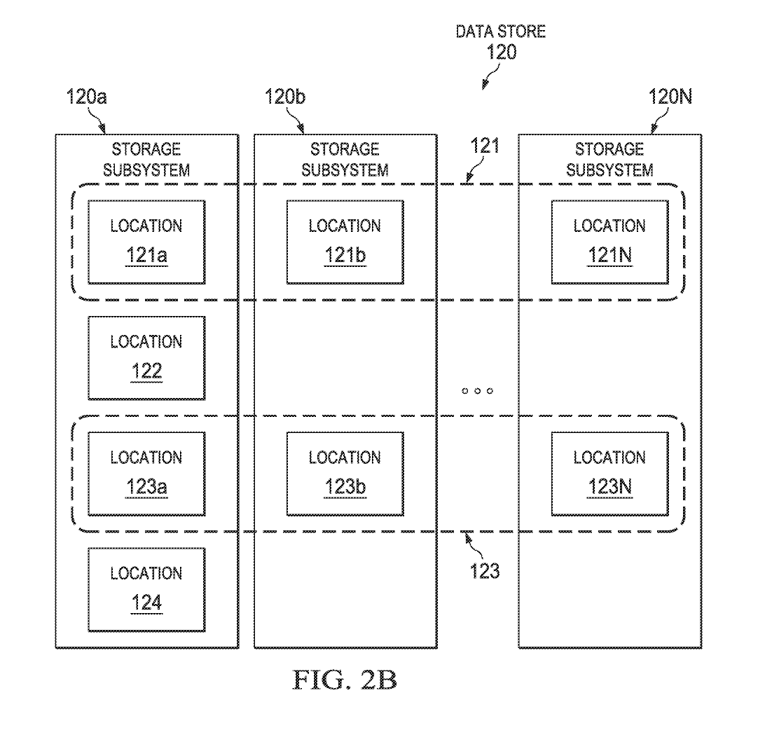

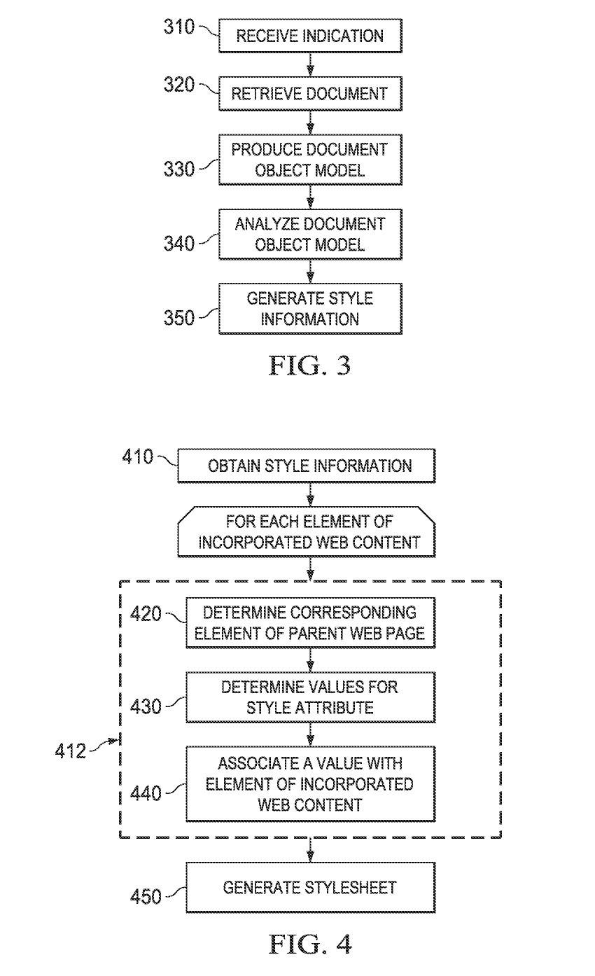

Turning now to FIG. 2A, a block diagram of one embodiment of style analysis system 102 is depicted. As shown, style analysis system 102 includes data store 120 and network interface 138 that are coupled to server 118. Server 118 may be one or more servers that are configured to singly or collectively provide functionality of style analysis system 102 or portions thereof. In some embodiments, network interface 138 may be part of a web server dedicated to processing network communications between computer systems and servers 118.

Data store 120 may in some embodiments include one or more storage subsystems. For example, data store 120 may include one or more disk drives coupled to one or more servers 118 (e.g. servers 118a, 118b, 118c). In other embodiments, data store 120 may include a plurality of storage systems configured as a storage area network, network attached storage, or any suitable storage subsystem configuration. In some embodiments, data store 120 may be remote from server 118. Data store 120 may in some cases be a virtual storage subsystem, accessed, for example, though a cloud computing provider. Referring also to FIG. 2B, an embodiment of data store 120 that includes multiple storage subsystem 120 (e.g. 120a, 120b, 120N) may store data in locations within a single storage subsystem (e.g., location 122 or location 124), or as data stored in a distributed manner (e.g., a distributed database) across several storage subsystems (e.g., location 121 or location 123).

Turning now to FIG. 2C, a block diagram of one embodiment of server 118 is depicted. Server 118 is representative of a plurality of servers in an embodiment of content association system 102, as well as a single system in an embodiment of style analysis system 102 that includes only one server. Style analysis system 102 may be any suitable type of device, including, but not limited to, a personal computer system, desktop computer, laptop or notebook computer, mainframe computer system, web server, workstation, or network computer. As shown, style analysis system 102 includes a processor unit 158, data store 120, input/output (I/O) interface 138 coupled via an interconnect 160 (e.g., a system bus). I/O interface 138 may be coupled to one or more I/O devices 148.

Processor unit 158 may include one or more processors. In some embodiments, processor unit 158 includes one or more coprocessor units. In some embodiments, multiple instances of processor unit 158 may be coupled to interconnect 160. Processor unit 158 (or each processor within 158) may contain a cache or other form of on-board memory. In general, style analysis system 102 is not limited to any particular type of processor unit or processor subsystem.

Data store 120 may be configured to store data that is usable by processor unit 158 (e.g., instructions executable by processor unit 158, data otherwise accessible by unit 158). Data store 120 may be implemented by any suitable type of physical memory media, including hard disk storage, floppy disk storage, removable disk storage, flash memory, random access memory (RAM-SRAM, EDO RAM, SDRAM, DDR SDRAM, RDRAM, etc.), ROM (PROM, EEPROM, etc.), and so on. Data store 120 may consist solely of volatile memory in one embodiment. Data store 120 may store program instructions executable by server 118 using processor unit 158, to cause server 118 to implement the various techniques disclosed herein.

I/O interface 138 may represent one or more of various types of interfaces configured to facilitate communication with other devices, according to various embodiments. In one embodiment, I/O interface 138 may include a bridge chip coupling a front-side bus to one or more back-side buses. I/O interface 138 may be coupled to one or more I/O devices 148 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

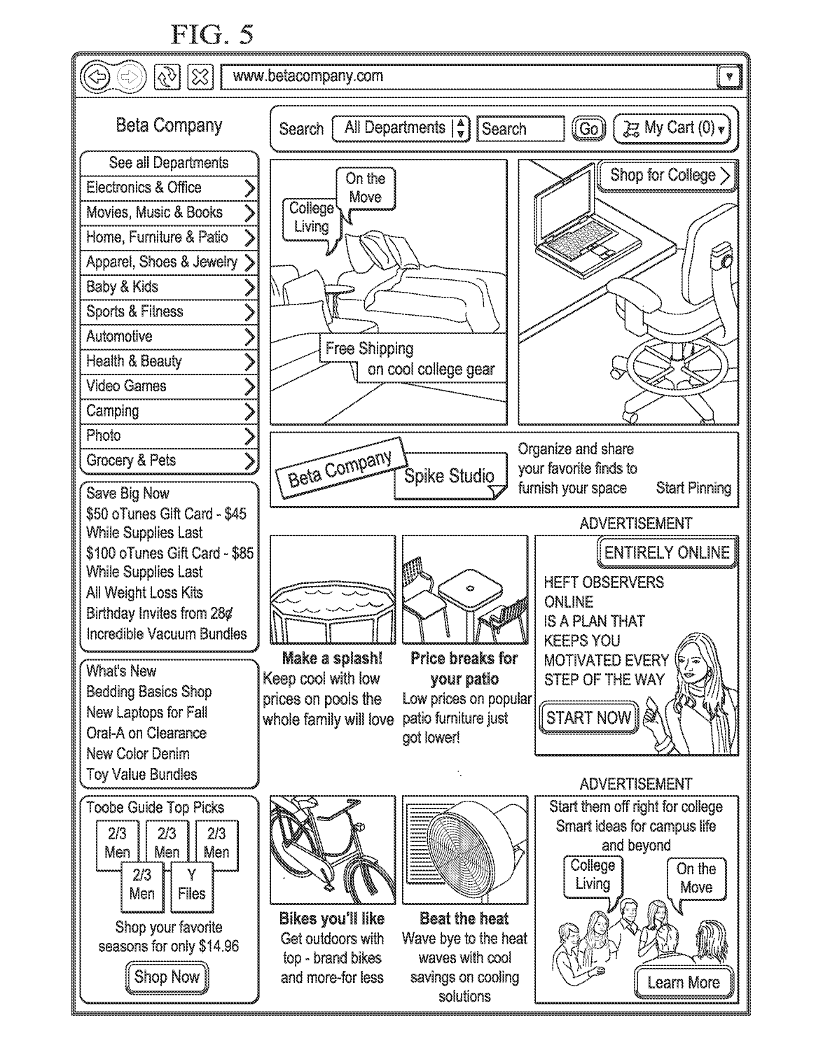

Referring now to FIG. 3, one embodiment of a method for the style analysis of a web page is depicted. Initially, at step 310, an indication of a document corresponding to a web page may be received. The indication may be, for example, a Universal Resource Identifier (URI) or a Universal Resource Locator (URL). The received indication may be used, at step 320, to retrieve a document corresponding to the web page. The document may, for example, include a hypertext markup language (HTML) document.

A document object model (DOM) may be produced (step 330) based on the document corresponding to the web page. This DOM may be produced based on, for example, a cascading style sheet (CSS) provided in association with the document corresponding to the web page.

The DOM may subsequently be analyzed (step 340) to generate (step 350) and store information indicative of one or more style attribute values that are present in the web page. These style attributes may include font-related style attributes, color related style attributes, and/or other types of style attributes as discussed above.

The generated information may comprise statistical information relating to the style attributes that are present in the web page that corresponds to the document. This statistical information may include, for example, statistical information for font-related attributes such as the number of characters having a particular style attribute value, and/or statistical information for color-related style attributes such as the number of pixels having a particular style attribute value for color (e.g., background color, image color).

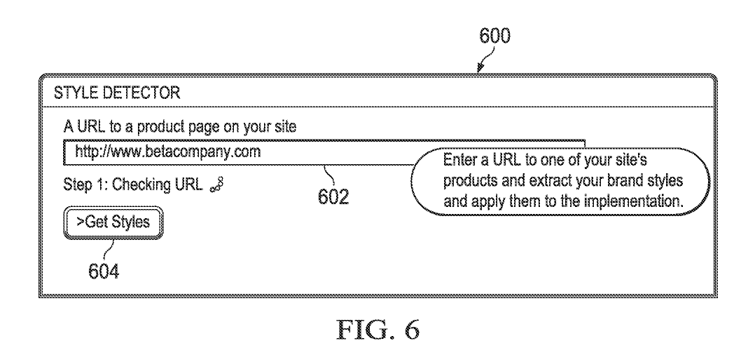

FIG. 4 depicts one embodiment of a method for associating style attribute values with web content, based on information indicative of the styling attribute values found within a web page into which the web content is to be incorporated. Again, for ease of reference, the web page on which the content is to be incorporated will be referred to as the parent web page, while the web content that will be incorporated into the parent web page (e.g., when the parent web page is rendered at a user's browser) will be referred to as the incorporated web content.

Initially, at step 410, the information indicative of the style attribute values that are used within the parent web page may be obtained. This information may be generated, for example, according to the method illustrated above with respect to FIG. 3, or by another method. As shown in block 412, several operations relating to determining and assigning style attribute values may be performed for various elements of the incorporated web content. For example, a corresponding element within the parent web page may be determined for an element in the incorporated web content (step 420). In one embodiment, the determination of the corresponding element may be made using mapping rules associating each of the set of elements of the incorporated web content with a corresponding element found within other portions of the parent web page.

At step 430, one or more values for style attributes of the corresponding elements within the parent web page can be determined. This determination may be made using the information obtained at step 410. One or more style attribute values may then be associated with the elements of the incorporated web content (step 440). In some cases, a default style attribute value or may be automatically assigned. In some cases, a user may select a style attribute value (e.g., from a listing of determined allowable style attribute values).

A style sheet corresponding to the incorporated web content and the parent web page can be generated (step 450). The generated style sheet may subsequently be used to specify, to a computer rendering the incorporated web content and the parent web page, style attribute values for the incorporated web content.

It may be helpful here to discuss embodiments of interfaces that may be utilized with certain embodiments of the systems and methods disclosed herein. Moreover, it may be useful to depict embodiments of these interfaces with respect to a particular example web page. Thus, suppose for purposes of the following discussion that a company called Beta Company provides a web site that includes a web page associated with the URL corresponding to “www.betacompany.com”.

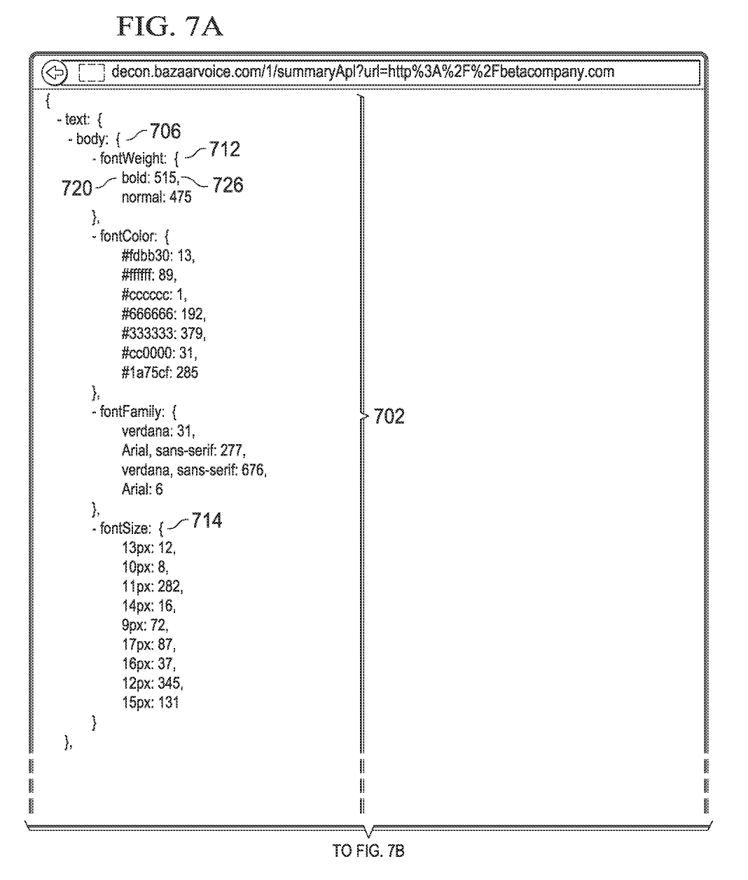

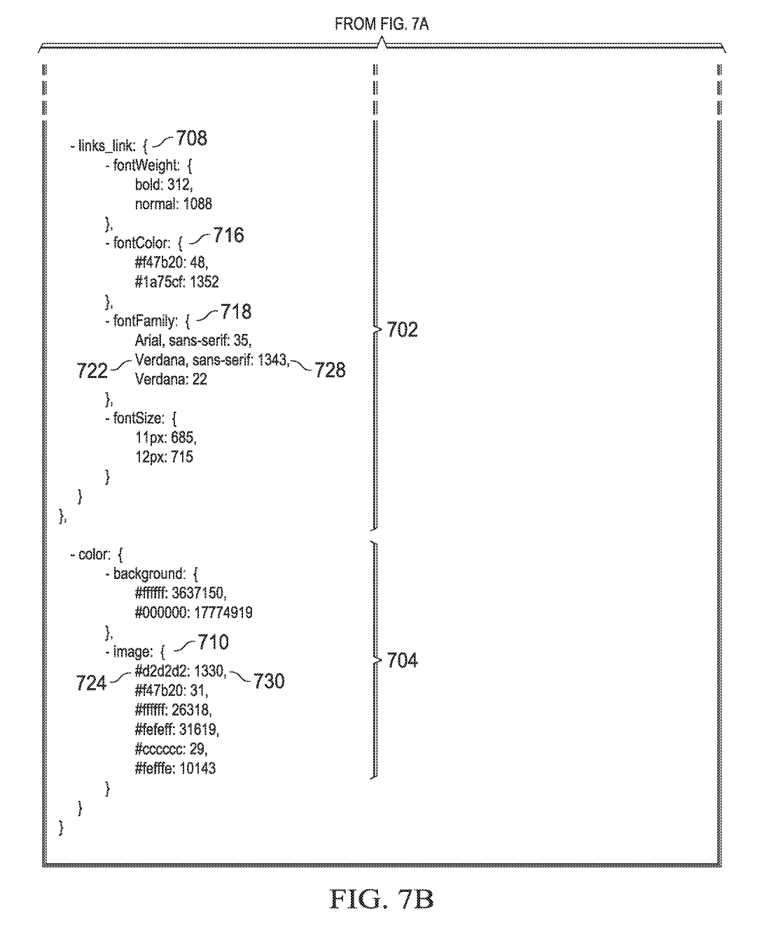

Turning first to FIG. 5, an embodiment of a rendered version of the web page associated with the example URL corresponding to “www.betacompany.com” is depicted. Suppose further now, that a user wishes to analyze the styling attributes of the web page located at the URL corresponding to “www.betacompany.com.” Looking now to FIG. 6, one embodiment of an interface through which a user may provide an indication of a document corresponding to a web page is depicted. In the example depicted, a user has entered the URL corresponding to “www.betacompany.com” in text box 602 of interface 600. Interface 600 may also present button 604 that is selectable by a user to indicate that he would like to determine the styling attributes associated with the web page corresponding to the URL entered in text box 602 (in the example here, corresponding to “www.betacompany.com”).

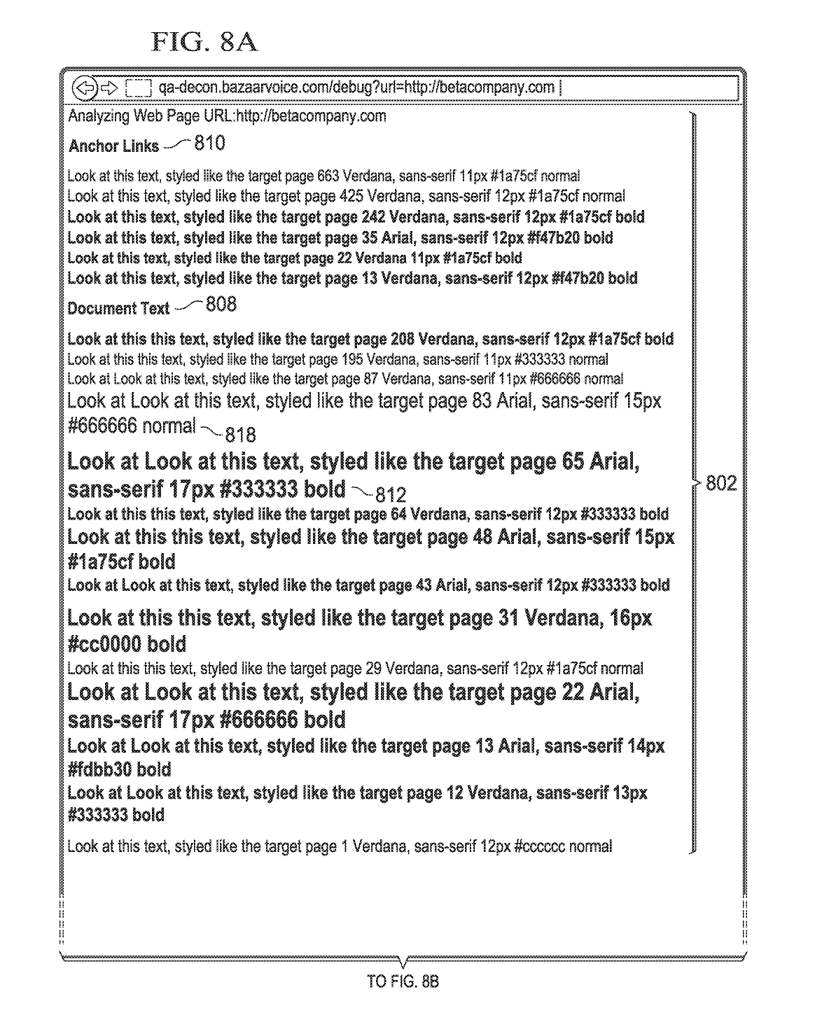

Once the user selects button 604, he may be presented with one or more interfaces that present identifications of one or more elements of the web page and representations of one or more style attribute values associated with the one or more elements. FIGS. 7-9 depict exemplary embodiments of such interfaces.

Referring first to FIGS. 7A and 7B, a text based embodiment of an interface that presents information indicative of the styling attributes found in the web page associated with the URL corresponding to “www.betacompany.com” is depicted. Such an interface may have a text representation of information indicative of font-related styling attributes and color-related (non-font) styling attributes. Here, for example, the interface includes text 702 representing information indicative of font-related style attributes, and text 704 representing information indicative of color-related (non-font) style attributes.

The interface may also present information identifying the elements (or classes of elements) found within the web page that correspond to the various style attribute values. For example, in FIG. 7A, the class of elements corresponding to body text is identified by text 706 (depicted as “body” as a subcategory of “text”), while the class of elements corresponding to link text is identified in FIG. 7B by text 708 (depicted as “links link” as a subcategory of “text”). An example of a class of elements corresponding to color-related (non-font) style attributes is text 710 in FIG. 7B, corresponding to image colors (depicted as “image” as a subcategory of “color”).

Continuing with the example shown in FIGS. 7A and 7B, the interface may present each of the identified elements or classes of elements along with representations of corresponding style attributes and style attribute values. For example, with respect to the class of elements corresponding to body text, the style attribute of font weight is represented by text 712 (depicted as “fontWeight” under the subcategory of “body”), while the styling attribute of font size is represented by text 714 (depicted as “fontSize” under the subcategory “body”). Similarly, with respect to the class of elements corresponding to link text, the style attribute of font color is represented by text 716 (depicted as “fontColor” under the subcategory “links link”), while the style attribute of font style is represented by text 718 (depicted as “fontFamily” under the subcategory “linksLink”).

The interface may also present various style attribute values that correspond to the presented style attributes. For example, the style attribute value “bold” for the style attribute of font weight (as relating to the class of elements corresponding to body text) is represented by text 720. Similarly, with respect to the element of link text, the value “Verdana, sans serif” for the style attribute of font family is represented by text 722. With respect to the element of images, the value “#d2d2d2” for the style attribute of image color is represented by text 724.

The interface may also present statistical information associated with a style attribute value. For example, text 726 shows that 515 characters are determined to have the style attribute value “bold” for the style attribute of “fontWeight” (as relating to the class of elements corresponding to body text). Similarly, text 728 shows that 1343 characters are determined to have the value of “Verdana sans-serif” for the style attribute of “fontFamily” (as relating to the class of the elements corresponding to body text). The text 730 shows that 1330 pixels are determined to have the value “#d2d2d2” for the style attribute of image color (e.g., as relating to one image or group of images).

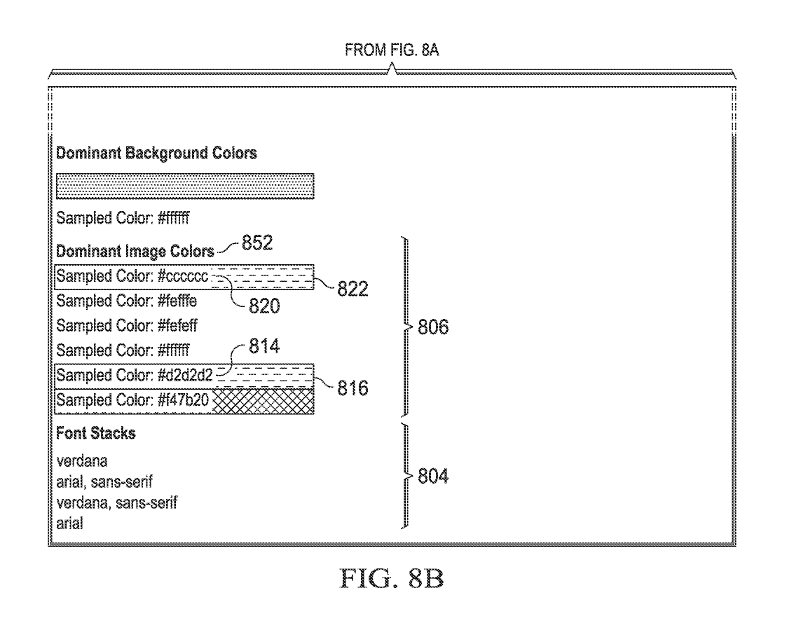

Moving now to FIGS. 8A and 8B, an embodiment of an interface that uses both text and graphical representations to present information indicative of style attributes and style attribute values found in the web page associated with the URL corresponding to “www.betacompany.com” is depicted. Such an interface may present text that describes various style attribute values. Here, for example, the interface includes text 802 and 804 (shown in FIGS. 8A 8B) representing information indicative of font-related style attribute values. The interface may also include graphic representations that may further present style attribute values to a user, such as, for example, text and graphic representations 806 (shown in FIG. 8B) representing information indicative of color-related attributes.

The interface may also present information identifying the elements (or classes of elements) found within the web page that correspond to the various style attribute values. For example, in FIG. 8A, the elements corresponding to “Document Text” is identified by text 808, while the elements corresponding to “Anchor Links” is identified by text 810. An example of text identifying elements corresponding to color-related (non-font) style attributes is text 852 (“Dominant Image Colors” heading) in FIG. 8B.

Continuing with the example shown in FIGS. 8A and 8B, the interface may present each of the identified elements or classes of elements along with representations of corresponding style attributes and style attribute values. For example, text 812 (shown in FIG. 8A) textually describes that with respect to “Document Text” elements found at “target page 65,” the style attributes of font style, font size, font color and font weight have respective values of Arial sans-serif, 17 point, #333333 and bold.

Additionally, text 812 may also present graphic representations of the style attributes of font style, font size, font color and font weight AND their respective values of Arial sans-serif, 17 point, #333333 and bold. For example, text 812 may be formatted and displayed according to one or more of these values (e.g., the font used for rendering text 812 may be Arial sans-serif, the size of rendered text 812 may be 17 point, the color of rendered text 812 may be the color corresponding to #333333, the text 812 may be rendered as bold font weight).

An example of elements corresponding to (non-font) style attributes such as image color, text 814 (shown in FIG. 8B) presents a textual description of the color value of #d2d2d2. Text 814 may also be presented along with a graphic representation of the color value, such as representation 816 that may be a rendered block of color corresponding to #d2d2d2. In some embodiments, text 814 may be rendered using the font color corresponding to #d2d2d2.

Furthermore, in some cases the various style attribute values may be presented in an order that is based on the quantity of occurrence (e.g., number of characters, number of pixels) corresponding to each particular style attribute value (or combination of style attribute values). For example, with respect to the elements corresponding to Document Text, text 812 may indicate that 65 characters of Document Text were found to have the combination of style attribute values Arial sans-serif, 17 point, #333333 and bold. Text 818 may indicate that 83 characters of Document Text were found to have the combination of style attribute values Arial sans-serif, 15 point, #666666 and normal. As shown in FIG. 8A, text 818 is displayed above text 812 and underneath text 808, thus indicating that the combination of style attribute values represented by text 818 occurred more frequently within Document Text elements than the combination represented by text 812.

Similarly, in some cases the various detected style attribute values (or combinations of style attribute values) corresponding to color-related style attributes may be presented as ordered according to a detected quantity (e.g., number of pixels) of each of the style attribute values. For example, in FIG. 8B the text 820 and graphic representation 822 associated with the detected color value #cccccc may be displayed above text 814 and graphic representation 816 that corresponds to detected color value #d2d2d2, thereby indicating that more pixels having the value #cccccc than pixels having the value #d2d2d2 were found.

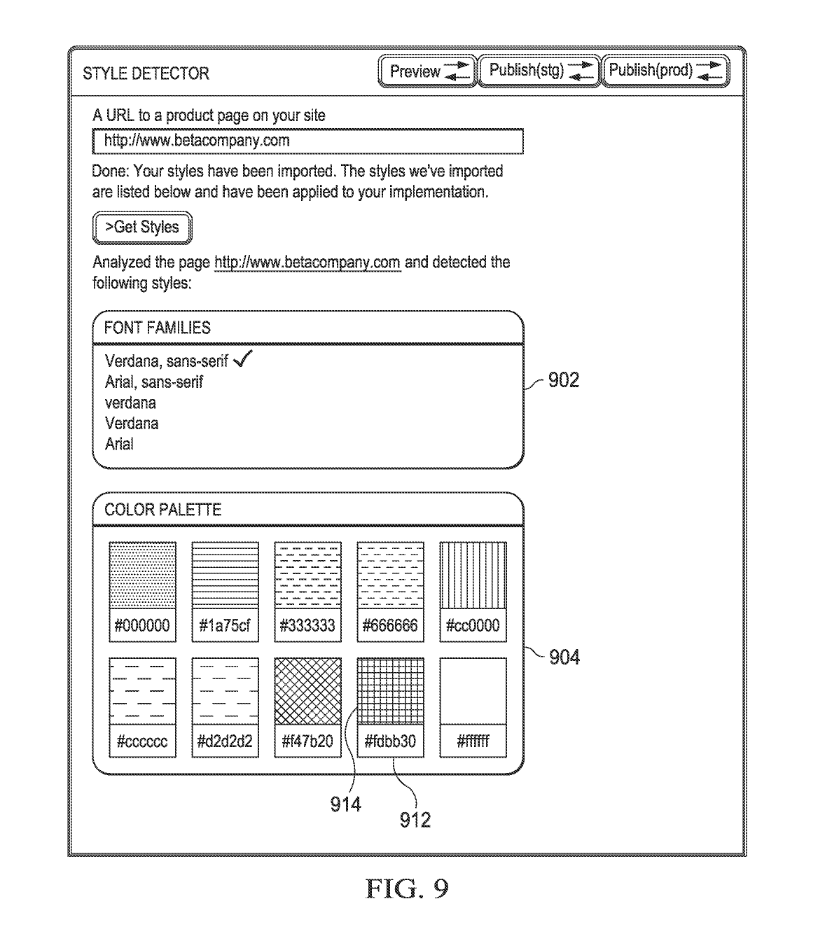

FIG. 9 depicts another embodiment of an interface that presents information indicative of the style attributes and the style attribute values found in the web page associated with the URL corresponding to “www.betacompany.com”. Such an interface may have an area 902 for depicting font-related style attributes and an area 904 for depicting color-related attributes. Here, area 902 displays text representing the detected values of the font type style attribute (labeled as “FONT FAMILIES”). Note here that these may be the values of particular style attributes detected with respect to any or all elements of the web page, or alternately only for a certain element or subset of elements (e.g., a list of style attribute values that is filtered to those corresponding only to a selected type of element or class of elements). These values may be displayed in order based on the frequency of the particular style attribute value. For example, as depicted in FIG. 9, there may be more characters having the font style Verdana sans-serif than characters of the web page having the font style Arial sans-serif. Furthermore, area 902 may only display a subset of the values detected, where the subset may be determined, for example, based on a quantity of occurrence of the value or some other criteria (e.g., all style attribute values exceeding an occurrence threshold, the N most frequent style attribute values).

Continuing with the embodiment depicted in FIG. 9, area 904 (labeled as “COLOR PALETTE”) displays text that provides a textual description of a style attribute value corresponding to a color (e.g., image color, background color), along with a graphic representation that presents a rendered block of the color. For example, text 912 describes the color value #fd8830, while block 914 presents a rendered block of the color corresponding to color value #fd8830. In some cases, a representation other than a hex color representation may be used (e.g., RGB composition, CMYK composition, other description). Again, in some cases area 904 may only display a subset of the values detected, where the subset may be determined, for example, based on a quantity of occurrence of the value or some other criteria.

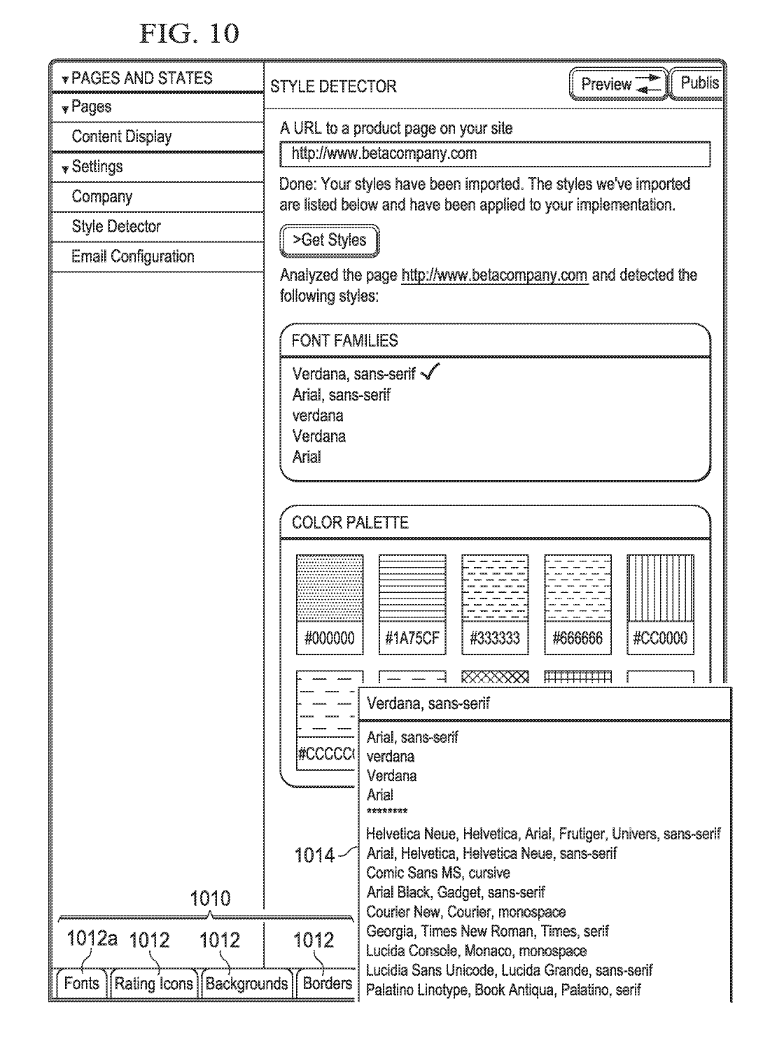

As discussed above, in many cases, a user may desire to select a style attribute value to assign to an element of incorporated web content. An interface may thus be utilized to allow a user to select a style attribute value (e.g., one that is already present in other portions of a parent web page) to associate to an element of web content that is to be incorporated into the parent web page. FIG. 10 depicts an embodiment of an interface that presents information indicative of the style attribute values that are found to be used in a parent web page, and also allows a user to select a style attribute value (e.g., one found to be used in the parent web page) to assign to the to-be-incorporated web content. More specifically, in the example depicted, the interface presents information indicative of the style attributes and style attribute values found in the parent web page associated with the URL corresponding to “www.betacompany.com,” and allows a user to select one or more of the found style attribute values to assign elements of web content that is to be incorporated in the web page.

Here, the interface includes area 1010 which is configured to allow a user to select elements (or classes of elements) of incorporated web content by selecting one of tabs 1012. In the example depicted, the user has selected the “Fonts” tab 1012a, which may cause presentation of candidate font-related style attribute values that the user may assign to elements used in, for example, body text or link text elements of web content that are to be incorporated into the parent web page. These candidate style attribute values may be based on the style attribute values that are determined to be used in other portions of the parent web page (e.g., values already used in body text and/or link text of other portions of the parent web page), and/or may be based on other rules (e.g., a style guide defining allowable styles).

When an element of the to-be-incorporated web content is selected, a set of values for a style attribute associated with the element may be presented to the user. Continuing with the example depicted in FIG. 10, when the user selects “font” tab 1012a, menu 1014 may be presented to the user. Menu 1014 may present a set of values of the font type style attribute that are available for assignment to the to-be-incorporated web content element.

As discussed above, menu 1014 may present the values for the style attribute in a particular order (e.g., based on a quantity of occurrence, based on rule-based preferences). Here, for example, the values of the font style attribute may be ordered according to the number of characters found to have those style attribute values in the parent web page associated with “www.betacompany.com”.

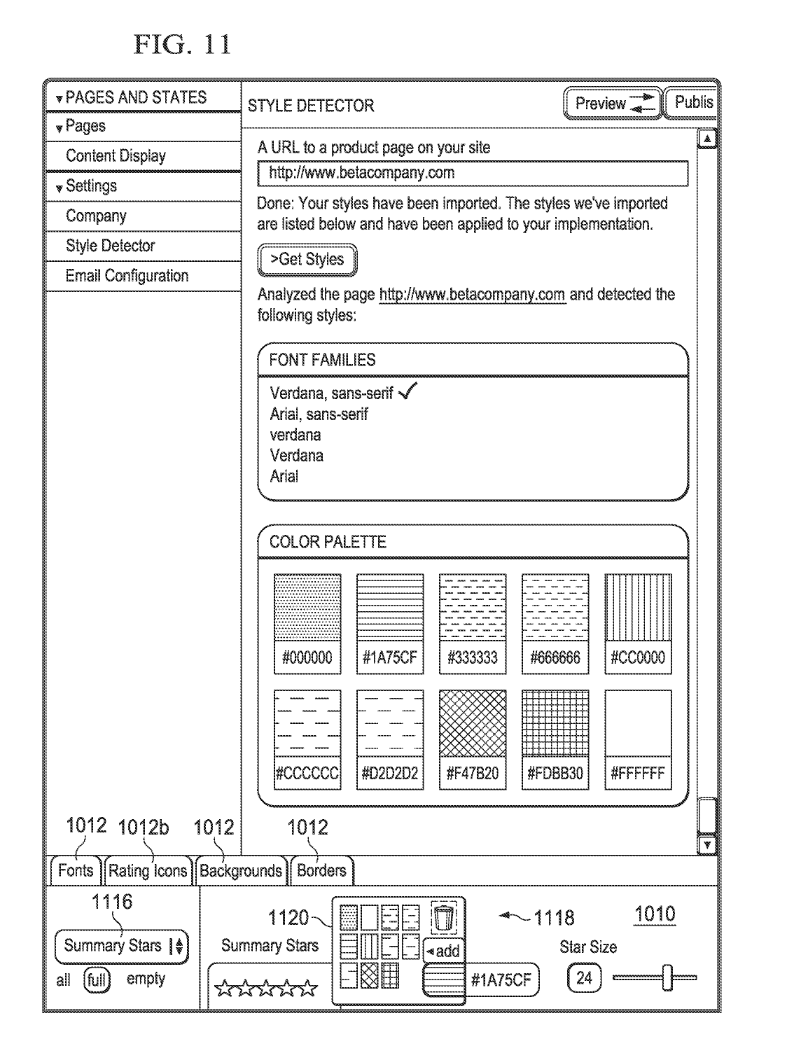

FIG. 11 depicts another embodiment of an interface that presents information indicative of the style attributes and style attribute values found in the parent web page, and allows a user to select a style attribute value present on the parent web page to assign to elements of web content that are to be incorporated into the parent web page. Again, in the example depicted the interface presents information indicative of the style attributes and style attribute values found in the parent web page associated with the URL corresponding to “www.betacompany.com,” and allows a user to select a style attribute value found to be present on the parent web page to be assigned to elements of web content that is to be incorporated into the web page.

Here, the interface includes area 1010 which is configured to allow a user to select elements (or classes of elements) of incorporated web content by selecting one of tabs 1012. In the example depicted the user has selected the “Rating Icons” tab 1012b, which may cause presentation of candidate icon-related style attribute values (e.g., color, size, shape) that the user may assign to rating icon elements used in, for example, web content that is to be incorporated into the parent web page. These candidate style attribute values may be based on the style attribute values that are determined to be used in other portions of the parent web page (e.g., values already used in body text and/or link text of other portions of the parent web page), and/or may be based on other rules (e.g., a style guide defining allowable styles). When this tab 1012b is selected, menu 1116 may be presented to allow a user to select a specific image element of the incorporated web content. Here the user has selected the image element “Summary Stars.”

When an element of the to-be incorporated web content is selected, a set of values for a style attribute associated with the element may be presented to the user. Continuing with the above example of FIG. 11, when the user selects the image element “Summary Stars” using menu 1116, area 1118 may be presented on the interface. Area 1118 may depict the image element (in this case the image element “Summary Stars”) and may present menu 1120 that provides a set of candidate values for the style attribute of image color for the particular image element. In particular, in the embodiment depicted, menu 1120 presents a graphic representation of each of the candidate values of the image color style attribute, where each graphic representation is a color block in the color associated with that value. Menu 1120 may allow a user to select one of the presented candidate style attribute values to assign to the particular element (e.g., “Summary Stars”).

As discussed above, menu 1120 may present the style attribute values in a particular order (e.g., based on a quantity of occurrence, based on rule-based preferences). Here, for example, the values of the image color style attribute may be ordered according to the number of pixels found to have that style attribute value in the images at other portions of the parent web page associated with “www.betacompany.com”.

Although embodiments have been described with respect to specific embodiments thereof, these embodiments are merely illustrative, and not restrictive. The description herein of illustrated embodiments is not intended to be exhaustive or to limit the precise forms disclosed herein (and in particular, the inclusion of any particular embodiment, feature or function is not intended to limit the scope to such embodiment, feature or function). Rather, the description is intended to describe illustrative embodiments, features and functions in order to provide a person of ordinary skill in the art context to understand embodiments without limiting embodiments to any particularly described embodiment, feature or function. While specific embodiments of, and examples, are described herein for illustrative purposes only, various equivalent modifications are possible within the spirit and scope of embodiments, as those skilled in the relevant art will recognize and appreciate. As indicated, these modifications may be made to embodiments in light of the foregoing description of illustrated embodiments and are to be included within the spirit and scope. Thus, while embodiments have been described herein with reference to particular embodiments thereof, a latitude of modification, various changes and substitutions are intended in the foregoing disclosures, and it will be appreciated that in some instances some features of embodiments will be employed without a corresponding use of other features without departing from the scope and spirit. Therefore, many modifications may be made to adapt a particular situation or material to the essential scope and spirit.

Reference throughout this specification to “one embodiment,” “an embodiment,” or “a specific embodiment” or similar terminology means that a particular feature, structure, or characteristic described in connection with the embodiment is included in at least one embodiment and may not necessarily be present in all embodiments. Thus, respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope.

In the description herein, numerous specific details are provided, such as examples of components and/or methods, to provide a thorough understanding of embodiments. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments. While embodiments may be illustrated by using a particular embodiment, this is not limited to any particular embodiment and a person of ordinary skill in the art will recognize that additional embodiments are readily understandable and are a part of this disclosure.

What is claimed is:

1. A method, comprising:
receiving, at a computing device, an indication of a document corresponding to a web page;
determining, at the computing device, one or more style attributes associated with the web page, wherein said determining includes:
causing a document object model to be produced based on the document corresponding to the web page; and
analyzing the document object model; and
generating, by the computing device, one or more style attribute values corresponding to the one or more style attributes.

2. The method of claim 1, wherein said determining one or more style attributes includes:
determining at least one of text color, text font, text size, or background color.

3. The method of claim 1, wherein said determining one or more style attributes includes:
determining a plurality of style attributes.

4. The method of claim 1, wherein said generating the one or more style attribute values includes:
generating one or more color-related style attribute values; and
ordering the color-related style attribute values based on quantity of color occurrence.

5. The method of claim 4, further comprising:
determining, by the computer system, a set of one or more default color-related style attribute values based on said ordering the color-related style attribute values.

6. The method of claim 1, wherein the indication of the document is a universal resource identifier corresponding to a hypertext markup language document.

7. The method of claim 1, further comprising:
comparing the generated one or more style attribute values with data indicating allowed style attribute values for the web page; and
identifying one or more elements of the web page that are non-compliant with the allowed style attribute values.

8. An article of manufacture including a computer-readable memory medium having stored thereon instructions that, in response to execution by a computer system, cause the computer system to perform operations comprising:
receiving an indication of a web page;
determining a plurality of style attributes associated with the web page; and
generating one or more style attribute values corresponding to the plurality of style attributes.

9. The article of manufacture of claim 8, wherein said determining includes:
causing a document object model to be produced based on the web page; and
analyzing the document object model.

10. The article of manufacture of claim 8, wherein said determining the plurality of style attributes includes:
determining at least one of line spacing, character padding, border, or margin.

11. The article of manufacture of claim 8, wherein said generating the one or more style attribute values includes:
generating a graphic representation of one or more font-related style attribute values that are representative of one or more font-related style attributes.

12. The article of manufacture of claim 11, wherein the generating the graphic representation includes ordering the font-related style attribute values based on quantity of character occurrence.

13. The article of manufacture of claim 12, wherein the operations further comprise:
determining a set of one or more default font-related style attribute values based on said ordering of the font-related style attribute values.

14. The article of manufacture of claim 8, wherein the operations further comprise:
comparing the generated one or more style attribute values with data indicating allowed style attribute values for the web page; and
identifying one or more elements of the web page that are non-compliant with the allowed style attribute values.

15. A system, comprising:
a computer comprising:
one or more processors;
memory, coupled to the one more processors, storing program instructions executable to cause the computer to:
receive an indication of a web page;
determine a plurality of style attributes associated with the web page; and
generate one or more style attribute values indicative of the plurality of style attributes.

16. The system of claim 15, wherein determining the plurality of style attributes includes:
causing a document object model to be produced based on the document corresponding to the web page; and
analyzing the document object model.

17. The system of claim 15, wherein generating the one or more style attribute values includes:
determining a first set of style attribute values corresponding to a first set of text on the web page; and
determining a second set of style attribute values corresponding to a second set of text on the web page, wherein the second set of style attribute values is different from the first set of style attribute values.

18. The system of claim 17,
wherein the first set of text corresponds to an unvisited link; and
wherein the second set of text corresponds to a visited link.

19. The system of claim 17,
wherein the first set of text corresponds to body text; and
wherein the second set of text corresponds to heading text.

20. The system of claim 15, wherein the program instructions are further executable to cause the computer to:
compare the generated one or more style attribute values with data indicating allowed style attribute values for the web page; and
identify one or more elements of the web page that are non-compliant with the allowed style attribute values.
